(19) United States
(12) Patent Application Publication
(10) Pub. No.: US 2026/0063795 A1
(43) Pub. Date: Mar. 5, 2026

(54) SCANNER AND METHOD FOR DETECTING AN OBJECT OF INTEREST

(71) Applicant: Rohde & Schwarz GmbH & Co. KG, Muenchen (DE)

(72) Inventors: Julian LANDESBERGER, Muenchen (DE); Julian ADAMETZ, Muenchen (DE); Frank GUMBMANN, Muenchen (DE); Andreas SCHIESSL, Muenchen (DE); Christian EVERS, Muenchen (DE)

(21) Appl. No.: 18/822,748

(22) Filed: Sep. 3, 2024

(51) Int. Cl. G01S 13/90; G01S 13/00; G01S 13/88

(52) U.S. Cl. CPC G01S 13/9064; G01S 13/003; G01S 13/887

(57) ABSTRACT

The present disclosure relates to a scanner for detecting an object of interest. The scanner includes at least one transmitter and/or at least one receiver for transmitting and/or receiving a signal in a range imaging setup. Further, the scanner has a beam and/or range focuser for improving the resolution of an obtained range image. The scanner also includes an evaluation circuit that is configured to analyze the signal for creating a range image and to determine the object of interest based on the range image created. The scanner is an access control scanner for controlling access to a restricted area. The scanner is configured to detect the presence of the object of interest using range imaging while the object of interest is moving relative to the scanner.

### FIELD OF THE DISCLOSURE

Embodiments of the present disclosure generally relate to a scanner and a method for detecting an object of interest, especially for detecting a moving object of interest.

### BACKGROUND

Many public areas like airports and government or administration buildings require the public to undergo a security check before allowing entrance. In recent years, the amount of public areas requiring a security check has significantly increased.

Nevertheless, it is still a struggle to find hidden non-metal objects, especially when hidden in shoe soles, the groin area or under headgear. Radar body scanner systems however are a widely used solution for security screening in order to identify hidden non-metal objects in an automated manner. However, due to the position of the sensors objects placed inside shoe soles, e.g. at a very low position, or in headgear, e.g. in a very high position, may be hard to detect. In addition, the material of the shoe soles may also affect the detection accuracy.

In order to improve the overall detection, manual detectors, e.g. metal detectors or x-ray detectors, may be used additionally. For instance, a person to be checked is required to remove the shoes such that the shoes can be scanned separately. Moreover, persons may be asked to remove their headgear, for instance in a separate room, such that a security person may check the headgear for forbidden items. However, this requires additional time and resources, thereby reducing the efficiency of the access point to the restricted area while simultaneously increasing the overall cost.

Accordingly, there is a need to provide a scanner which improves detecting an object of interest while achieving a high scanning throughput.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a scanner for detecting an object of interest, e.g. an object that might relate to a hidden threat, for instance a knife, a scissor, a cutter or similar objects. In an embodiment, the scanner comprises at least one transmitter and/or at least one receiver for transmitting and/or receiving a signal in a range imaging setup. The scanner may also comprise a beam and/or range focuser for improving the resolution of an obtained range image. The scanner may also comprise an evaluation circuit that is configured to analyze the signal for creating a range image. In an embodiment, the scanner is capable of determining the object of interest based on the range image created. In an embodiment, the scanner is an access control scanner for controlling access to a restricted area. In addition, the scanner is capable of detecting the presence of the object of interest using range imaging while the object of interest is moving relative to the scanner.

Put differently, the scanner is able to receive a signal reflected by the object of interest, which may be evaluated by the evaluation circuit. In order to obtain a high resolution, based on which an informed decision can be made, the scanner comprises the beam and/or range focuser that is configured to improve the quality of the obtained range image.

In an embodiment, the evaluation circuit may include or be a processor or a microprocessor with a detection algorithm or an artificial intelligence installed thereon that is configured to detect and determine the object of interest when processing the range image created.

In an embodiment, the first detection direction of the scanner may be orientated in a plane that differs from the plane of movement of the object of interest. That is to say, the first detection direction of the scanner may be vertical while the object of interest moves in a plane orthogonal to the scanner, namely in a horizontal direction. As indicated above, the object of interest may be potential threating object that is carried by a person that moves while passing the scanner.

In an embodiment, the first detection direction of the scanner is used for scanning shoe soles of a person, for example from below such that the signal penetrates the shoe sole from below. Accordingly, the at least one transmitter and/or at least one receiver may be located in a plane below a plane in which the object of interest might be located, e.g. within a shoe sole. In an embodiment, the at least one transmitter and/or at least one receiver may be located in a bottom portion of the scanner. Besides shoe soles, this setup is also feasible for checking a groin region of a person or a wheelchair.

In an embodiment, the scanner may also be used for scanning a headgear. In this application scenario, the at least one transmitter and/or at least one receiver may be located in a plane on top of a plane in which the object of interest might be located. Again, the first detection direction of the scanner may be vertical while the object of interest moves in a plane orthogonal to the scanner, namely in a horizontal direction. Accordingly, the signal penetrates the headgear from the top. In an embodiment, the at least one transmitter and/or at least one receiver may be located in a ceiling portion of the scanner.

In summary, the at least one transmitter and/or at least one receiver in an embodiment may be located in a plane below or on top of a plane in which the object of interest might be located.

Since the scanner is configured to detect the presence of the object of interest using range imaging while the object of interest is moving relative to the scan, it is ensured that the object of interest is scanned along at least two axes being perpendicular to each other. For instance, the object of interest is scanned along a longitudinal axis (due to the movement of the object of interest, e.g. the movement of the person carrying the object of interest) and a transverse axis (due to the first detection direction).

The general idea is to use the motion of a person, for instance during entry of the scanner. Due to the movement, an area can be scanned for the object of interest piece by piece along the longitudinal axis, for instance a shoe, a headgear or a wheelchair. The area might encompass the object of interest. Simultaneously, the scanner scans the area along the transverse axis due to the orientation of the at least one transmitter and/or the at least one receiver, namely the first detection direction of the scanner, which is defined by the at least one transmitter and/or the at least one receiver.

In an embodiment, the signal may relate to an x-ray signal, an ultrasonic signal or a radar signal. Accordingly, the at least one transmitter and/or at least one receiver may relate to an x-ray transmitter/receiver, an ultrasonic transmitter/receiver or a radar transmitter/receiver, respectively.

In an embodiment, the at least one transmitter and the at least one receiver may be part of a time-of-flight, TOF, detection system, e.g. a system that detects the object of interest by determining a time of flight of the respective signal.

According to an aspect of the disclosure, the at least one transmitter and the at least one receiver, for example, are implemented commonly such that the scanner comprises at least one transceiver. By using a transceiver instead of a separate transmitter and a separate receiver, the amount of parts required for the scanner can be decreased as the transceiver may act as the transmitter and the receiver, e.g. controlled accordingly. The resolution can be increased as the density of active parts can be increased when using transceivers.

In an embodiment, the scanner comprises at least one antenna array comprising several antennas. The antennas or the several antennas comprise transmission antennas as well as reception antennas. By increasing the amount of antennas used, the resolution of the obtained range image is increased such that a more meaningful result may be obtaining using the evaluation circuit. In case the antenna array comprise (transceiving) antennas that can be controlled to act as transmission antennas and reception antennas, the resolution can be increased further.

According to an aspect of the disclosure, the at least one antenna array, for example, is a monostatic array or a multistatic array. Hence, the antenna elements may establish a monostatic radar wherein the transmitter, e.g. the transmission antenna, and the receiver, e.g. the reception antenna, are co-located, for instance by an offset, resulting in a monostatic offset arrangement. However, the antenna elements may also associated to a shared area of coverage, thereby establishing a multistatic radar.

Generally, the at least one transmitter may relate to at least one transmission antenna, whereas the at least one receiver may relate to at least one reception antenna.

According to an embodiment, the beam and/or range focuser comprises a motion sensor that is configured to determine and measure the movement of the object of interest. For example, the motion sensor may determine the velocity and path of the movement of an area, which might encompass the object of interest, relative to the scanner, e.g. a shoe, a headgear or a wheelchair. Since the motion sensor determines and measures the movement of the area, e.g. the shoe, the motion sensor simultaneously determines and measures the movement of the object of interest. Since the velocity and path are measured, the trajectory is measured. The motion sensor may be a camera that not only determines and measures the movement of the object of interest but also monitors the scanner itself such that tempering attempts may be discouraged. Alternatively, the motion sensor may be any other kind of passive infrared (PIR), microwave of dual tech motion sensor.

In embodiments in which the scanner includes a motion sensor, the evaluation circuit can be connected with the motion sensor such that the evaluation circuit is configured to create the range image using the signal and data received from the motion sensor. By including the information determined about the movement of the object of interest, the resolution of the range image may be increased and the object of interest can be detected more easily.

Alternatively, if the scanner does not comprise a motion sensor, the data obtained by the scanner, namely the data obtained from the signal, may be used to estimate the movement of the object of interest. However, the range image obtained solely from the data of the signal has a comparatively low resolution.

In an embodiment, the scanner can be an inverse synthetic aperture radar (ISAR). In this case, the evaluation circuit is configured to create the range image using data received from the inverse synthetic aperture radar and data received from the motion sensor, e.g. velocity information. ISAR is a well-known radar principle which requires the movement of the object of interest to be known. Hence, the combination of ISAR and motion sensor can be used to obtain a range image with a high resolution. Further, by using ISAR, the movement of the object of interest can be used to execute the scanning process such that no mechanical moving parts are required in the scanner itself reducing maintenance costs and allowing for a robust scanner.

According to a further aspect of the disclosure, the beam and/or range focuser comprises, for example, a focusing device, for instance a lens. Accordingly, the at least one transmitter together with the focusing device provides a fan beam. The fan beam has a small width in one direction, for example a small width in the first detection direction. When using the fan beam, the small width of the emitted radiation is pointed in the direction of motion of the object of interest. That way, the movement of the object of interest can be monitored by the fan beam itself such that a separately formed (hardware) motion sensor is not required. Put differently, by using the focusing device it is possible to reduce a detection area in the direction of motion of the object of interest enough to receive a reflected signal at a determined scanning point of the scanner.

In an embodiment, the focusing device may be located in front of the at least one transmitter and/or the at least one receiver such that a transmitted signal and/or a signal to be received is focused by the focusing device. The focusing device, for instance established by a lens, may be formed separately with respect to the at least one transmitter and/or the at least one receiver, thereby reducing the overall costs. However, the focusing device may also be integrated within the at least one transmitter and/or the at least one receiver, thereby forming a fan-beam antenna. In this scenario, the focusing device may relate to a reflector, for instance a truncated paraboloid reflector or a circular paraboloid reflector.

As an alternative to the focusing device made of hardware, it is also possible to use a software for beam forming in order to create a fan beam. Further, it is also possible to use a software for three-dimensional (3D) lens imaging in order to achieve the same effect as when using a fan beam antenna. Hence, the beam and/or range focuser may be established by software at least in parts.

In summary, in embodiment in which the scanner uses either a focusing device or a beam forming software, the scanner does not require a (hardware) motion sensor in order to obtain a high resolution range image as the detection area can be and/or is limited in the direction of motion of the object of interest such that the detection position is sufficiently known.

In an embodiment, the beam and/or range focuser for improving the resolution of an obtained range image may relate to hardware components, e.g. the (hardware) motion sensor that provides velocity information for the ISAR scanner or the focusing element, and/or software components, e.g. an estimation of velocity based on evaluating the data obtained from the signal for the ISAR scanner or the software-based beam forming and/or the software-based three-dimensional (3D) lens imaging.

In an embodiment, the scanner may further comprise a platform onto which a standing surface for a person is provided. The at least one transmitter and/or the at least one receiver are/is positioned at an edge of the platform, which is assigned to an entrance and/or an exit of the scanner. By providing a platform onto which a person carrying the object of interest can step without damaging the at least one transmitter and/or the at least one receiver, the durability of the scanner can be improved. Further, this arrangement ensures that the person can be scanned for the object of interest while entering or leaving the scanner, e.g. during the motion of the person.

Of course the platform can also be accessed by disabled persons using wheelchairs such that the wheelchair can be scanned as well.

Moreover, the platform may have a sign corresponding to an instruction printed thereon, so that it is abundantly clear to anyone that the scanner has to be passed by stepping onto the platform.

The platform may be elevated compared to a floor on which the scanner is installed so as to establish an accommodation space for the at least one transmitter and/or the at least one receiver. By raising the platform compared to the floor, the scanner can be installed at any location without having to worry about providing a recess in the floor to install the at least one receiver and/or the at least one transmitter in order to prevent any damage to the at least one transmitter and/or the at least one receiver.

In embodiments in which the platform is elevated compared to the floor, there may be a step from the floor onto the standing surface which is kept as small as possible. In order to improve accessibility, it is also possible to install a ramp before and after the platform with a gentle slope such that, for example wheelchair users are also enabled to get onto the platform, thereby passing the at least one transmitter and/or the at least one receiver. Accordingly, by providing the ramp, the accessibility of the platform is improved.

According to another aspect of the disclosure, the scanner, for example, can further comprise at least one detector with a first detector panel and a second detector panel. In an embodiment, the first panel and the second panel are positioned at a distance from each other such that a passage is defined between the first panel and the second panel. The at least one transmitter and/or the at least one receiver are/is positioned in a plane perpendicular to an extension direction of the first detector panel and the second detector panel. The at least one transmitter and/or the at least one receiver however have a detection direction, namely the first detection direction, which is parallel to the extension direction of the first detector panel and the second detector panel. In an embodiment, the direction of the first detector panel and the second detector panel are orientated in a vertical manner. Each of the first panel and the second panel may comprise antennas which are used to scan the entire person.

In an embodiment, the detector can be a radar scanner, for example a radar body scanner system, that is configured to provide additional data regarding the object of interest. Additionally, the detector can provide information about the movement so that a motion sensor is not required even when the detection area is not defined by a fan beam.

Contrary to the at least one transmitter and/or the at least one receiver, the detector scans a person for an object of interest while the person stands still between the detector panels, e.g. on the platform.

Consequently, the person passes the at least one transmitter and/or the at least one receiver while entering or leaving the platform such that the person is scanned from below and/or from the top during its motion, whereas the lateral scan of the person takes place when the person is standing on the platform by the detector, namely the detector panels.

Thus, the detector together with the at least one transmitter and/or the at least one receiver ensure a full body scanner, as the person is scanned from above and/or from below additionally due to the at least one transmitter and/or the at least one receiver.

Especially when the scanner is used in a security context, combining the at least one transmitter and/or the at least one receiver with the detector enables a higher throughput as only one security station needs to be passed, at which the scanner is provided.

When the scanner also comprises the detector, the evaluation circuit can be configured to combine data obtained from the signal and data received from the detector. Put differently, only one evaluation circuit is required. The evaluation circuit may be configured to process, e.g. to fuse and/or overlay, the data obtained from the signal associated with the at least one transmitter and/or the at least one receiver and the data received from the detector such that a more complete and detailed image may be obtained. This allows for a more significant result regarding the detection algorithm and accordingly decreases the amount of false alarms given by the evaluation circuit.

According to an aspect of the disclosure, the at least one transmitter and/or the at least one receiver, for example, are/is maintained within position during the scanning. That is to say, the at least one transmitter and/or the at least one receiver is fixed and not moving such that the scanner can be built more robustly and requires less maintenance.

According to a further aspect of the disclosure, a method for detecting an object of interest is provided. In an embodiment, the method comprises:
Providing a scanner that is an access control scanner for controlling access to a restricted area;
Performing a scan with the scanner by transmitting a signal and receiving a reflected signal while the object of interest is moving relative to the scanner;
Constructing a range image from the received signal,
Analyzing the range image, thereby obtaining an analyzation result, and
Detecting the presence of the object of interest by using the analyzation result.

Put differently, the movement of the object of interest is used to obtain a range image which may be analyzed in order to determine the presence of the object of interest, for example with an evaluation circuit comprising a detection algorithm and/or an artificial intelligence. Accordingly, a high resolution range image may be created such that threats, i.e. the object of interest, may be detected faster while at the same time decreasing the amount of false alarms.

According to an aspect of the method, a resolution of the range image, for example, is enriched by processing data associated with the received signal with data collected by a motion sensor, wherein the motion sensor detects the movement and velocity of the object of interest. As explained previously, by combining the data received by the at least one receiver and the data obtained by the motion sensor, the resolution of the range image can be increased such that more meaningful results can be obtained.

According to an alternative embodiment, a resolution of the range image is improved by creating a fan beam. The fan beam may, for example, be created by using a focusing device (applied on a signal transmitted) or by using a beam forming software (applied during post-processing). The focusing device may be a separately formed part that is placed in front of the at least one transmitter and/or the at least one receiver. Alternatively, the focusing device is integrated into the at least one transmitter and/or the at least one receiver, for instance by a reflector. A fan beam is an alternative to the motion sensor since the width of the fan beam in the direction of motion is small enough to correctly determine the motion, for example the moment when the data is received.

In an embodiment, at least one detector with a first detector panel and a second detector panel can be used additionally, wherein the first detector panel and the second detector panel are positioned at a distance from each other such that a passage is formed between the first detector panel and the second detector panel. By additionally using at least one detector, a more complete and detailed range image can be obtained, such that the object of interest, for example threats, can be detected more reliably and the amount of false alarms given can be reduced. The detector is typically used to perform a lateral scan of the person, whereas the scan performed by transmitting a signal and receiving a reflected signal while the object of interest is moving relative to the scanner provides a scan from below and/or from the top.

To obtain the most complete and detailed range image possible, at least one transmitter and/or at least one receiver, used for performing the scan while the object of interest is moving relative to the scanner, are/is positioned in a different plane than the first detector panel and the second detector panel. For example, the at least one transmitter and/or the at least one receiver may be positioned orthogonal to an extension direction of the detector (panels). Accordingly, the object of interest can be scanned from multiple angles. The data associated with the signal received is combined with the data received from the at least one detector and by the evaluation circuit.

In an embodiment, the at least one transmitter and/or the at least one receiver are/is positioned at an entrance and/or an exit of the scanner such that a person entering and/or leaving the scanner is scanned during its motion by using the at least one transmitter and/or the at least one receiver. For example, when the scanner is part of a radar body scanner system, the person is only required to use the radar body scanner system solely such that a high throughput can be achieved and long wait times can be avoided compared to using two different stations for performing a check of the shoes or headgear and additionally a scan of the body.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a top view of a of the scanner according to an embodiment of the present disclosure;

FIG. 2 shows a cross-section of the scanner shown in FIG. 1 along the line A-A;

FIGS. 3A to 3D show a top view of a representative scanning process using the scanner shown in FIGS. 1 and 2, wherein FIGS. 3A to 3D each show different times of the scanning process;

FIGS. 4A to 4D show the scanning process shown in FIGS. 3A to 3D in a cross-sectional view, wherein FIGS. 4A to 4D each show different times of the scanning process;

FIG. 5 shows a top view of the scanner of FIG. 1 with an offset monostatic array instead of a monostatic array;

FIG. 6 shows a top view of the scanner of FIG. 1 with a multistatic array instead of a monostatic array;

FIGS. 7A-7C show a cross-sectional view of the scanner of FIG. 1 using a different beam and/or range focuser;

FIG. 8 shows a perspective view of the scanner according to FIG. 1; and

FIG. 9 shows a flow chart illustrating a method for detecting an object of interest according to an embodiment of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

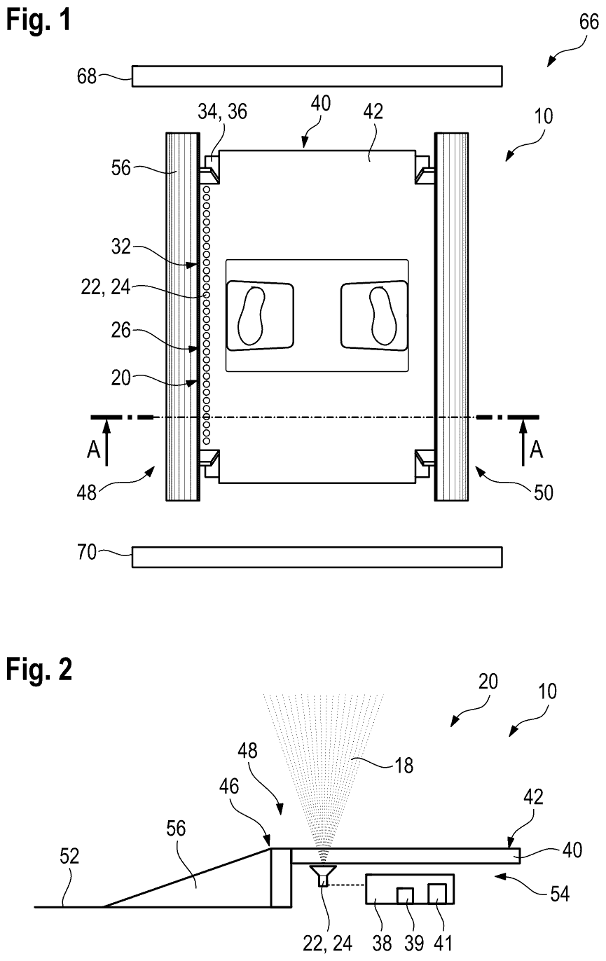

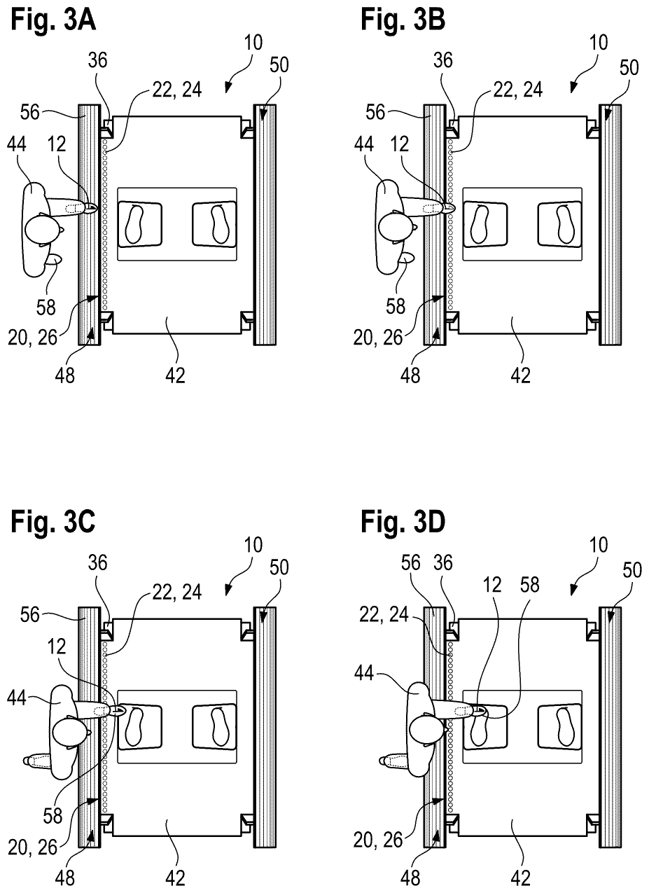

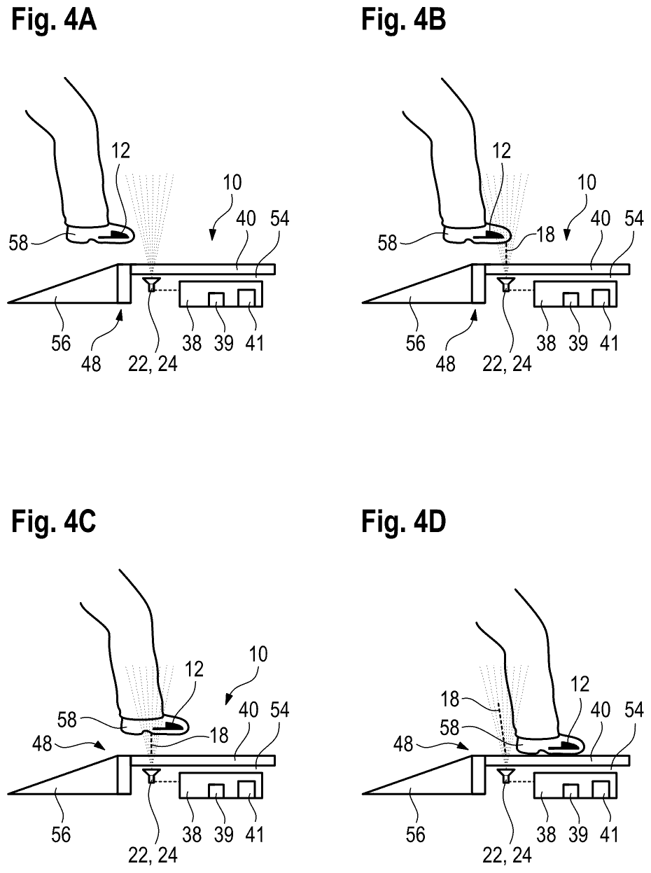

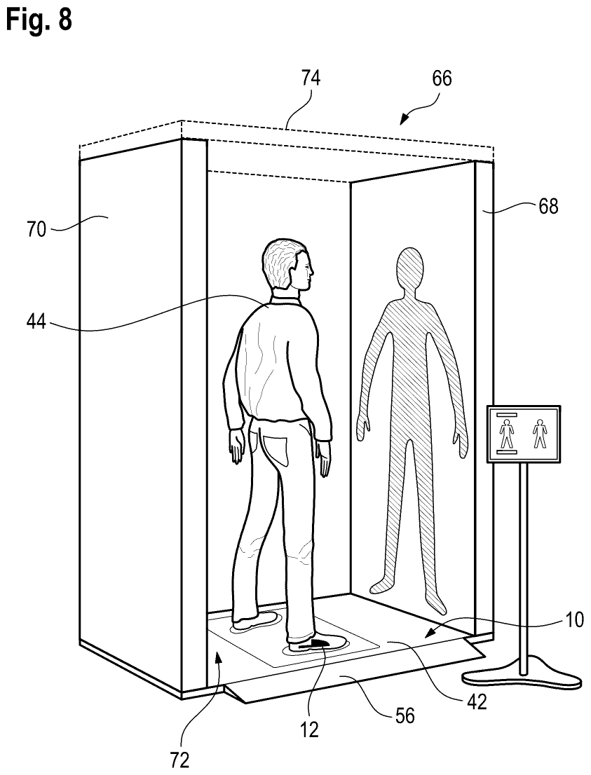

FIGS. 1, 2, and 8 show a scanner 10 according to one or more embodiments of the present disclosure, wherein FIG. 1 shows a top view of the scanner 10, FIG. 2 shows a cross section of the scanner 10 along the line A-A, and FIG. 8 shows a perspective view of the scanner 10. The scanner 10 is configured to detect an object of interest 12, as shown in FIG. 8. In an embodiment, the presence of an object of interest 12 is detected by using range imaging while the object of interest 12 is moving relative to the scanner 10 as will be described later in more detail with respect to FIGS. 3 and 4.

In an embodiment, the scanner 10 is suitable for use as an access control scanner for controlling access to a restricted area, such as administrative and/or government buildings, airports, concerts, etc. Accordingly, the object of interest 12 that is supposed to be detected by the scanner 10 may be a knife, a cutter, an explosive, or another potential threat. Put differently, the scanner 10 is intended to detect an object of interest 12 that poses a threat to the public.

In order to be able to detect the object of interest 12, the scanner 10 comprises at least one transmitter 14 and at least one receiver 16 for transmitting and/or receiving a signal 18 in a range imaging setup 20. In the embodiment of

In the embodiment of FIG. 1, the scanner 10 comprises a plurality of transmitters 14 and a plurality of receivers 16 which are implemented commonly such that the scanner 10 comprises a plurality of transceivers 22. Accordingly, the transceivers 22 are able to transmit and receive the signal 18 such that the amount of components constituting the scanner 10 can be reduced or the density of transmitters 14 and receivers 16 can be increased, thereby improving the resolution of the scanner 10.

According to the example embodiment shown, the transceivers 22 include antennas 24 which are arranged in an antenna array 26, for example a monostatic antenna array. As the antennas 24 correspond to transceiving antennas, each of them can be controlled to act as a transmission antenna 28 and a receiving antenna 30. Of course, it is also possible in other embodiments that the scanner 10 comprises more than one antenna array 26.

In an embodiment, the scanner 10 is an inverse synthetic aperture radar (ISAR) scanner 32 such that each antenna 24 is mechanically fixed and does not move. Instead, the motion of the object of interest 12 is used to perform the scan.

In an embodiment, the scanner 10 further comprises a beam and/or range focuser 34 which is configured to improve the resolution of the obtained range image. The beam and/or range focuser 34 is beneficial as ISAR 32 relies on the motion of the object of interest 12 being known, in particular its velocity and its movement.

For instance, the beam and/or range focuser 34 comprises a motion sensor 36. The motion sensor 36 is configured to determine and measure the movement of the object of interest 12, for example a shoe hiding the object of interest 12, such that a range image with a high resolution can be obtained which allows for a significant result to be obtained by the scanner 10.

In an embodiment, the motion sensor 36 can be a camera that additionally monitors an rea of the scanner 10 in order to prevent someone from tempering the scanner 10. Alternatively, any other kind of motion sensor 36 that is able to determine and measure the movement of the object of interest 12 may also be used, for example any kind of passive infrared (PIR), microwave or dual tech motion sensor.

In an embodiment, the scanner 10 further comprises an evaluation circuit 38 that is configured to analyze the signal 18 for creating the range image and to determine the object of interest 12 based on the range image created. In an embodiment, the evaluation circuit 38 may be implemented as a processor or microprocessor which has a detection algorithm 39 and/or an artificial intelligence (AI) 41 installed thereon. Accordingly, the detection algorithm 39 and/or the AI 41 are programmed to issue a warning when the presence of the object of interest 12 is detected.

In an embodiment, the evaluation circuit 38 is not only connected to the antenna array 26, but also to the motion sensor 36. Accordingly, the evaluation circuit 38 creates the range image using the signal 18, i.e. the data, obtained from the antenna array 26 as well as data received from the motion sensor 36.

In an embodiment, the scanner 10 comprises a platform 40 with a standing surface 42 for a person 44 shown in FIG. 3. Accordingly, the person 44 carrying the object of interest 12 has to step onto the platform 40, thereby passing the antenna array 26, such that the scanner 10 can use the motion of the person 44 stepping onto the platform 40 for scanning and detecting the presence of the object of interest 12.

In an embodiment, the antennas 24 are positioned at an edge 46 of the platform 40 that is assigned to an entrance 48 of the scanner 10. Alternatively and/or additionally, a second antenna array 26 may be provided at the opposite edge 46 which is assigned to an exit 50 of the scanner 10.

In an embodiment, the scanner 10 is elevated compared to a floor 52 on which the scanner 10 is installed. By having a raised platform 40 compared to the level of the floor 52, an accommodation space 54 is created below the standing surface 42 and above the floor 52 such that the antenna array 26 and the evaluation circuit 38 can be positioned in the accommodation space 54.

However, by having a raised platform 40 a step is created such that the scanner 10 may not be accessible for everyone. For this reason, the scanner 10 may further comprise a ramp 56 having a shallow slope, making the scanner 10 accessible for more people, for example people limited in their movements or wheelchair users. Consequently, the scanner 10 can also be used for scanning wheelchairs.

With reference to FIGS. 3A-3D, FIGS. 4A-4D and FIG. 9, an example of a method for detecting the object of interest 12 will be described hereinafter. FIGS. 3A-3D show a top view of the scanner 10 and FIGS. 4A-4D show a partial cross section of the scanner 10. The scanner 10 shown is the same scanner 10 as was described in regards to FIGS. 1 and 2 above.

In a first step S1 the scanner 10 is provided such that the scanner 10 corresponds to an access point for a restricted area. A person 44 wanting to get access to the restricted area therefore has to pass the scanner 10.

In FIGS. 3A and 4A, the person 44 is just entering, e.g., stepping onto platform 40. For example, the person 44 has just moved the foot 58 towards the platform 40 as the foot 58 of the person 44 is currently over the ramp 56. In this position, the foot 58 is not yet detected by the scanner 10.

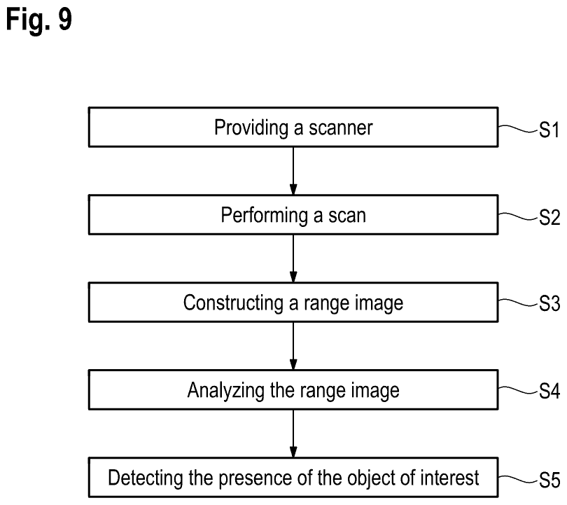

As soon as the foot 58 enters the beam, i.e. the transmitted signal 18, the scan is started, as also indicated in step S2 in FIG. 9. The transmitted signal 18 is reflected by the person 44, for example the shoe at the foot 58, and the reflected signal 18 is therefore received by the receiving antenna 30 of the antenna array 26.

The transmitted signal 18 partly penetrates the shoe (sole) such that the signal 18 is also reflected by an object of interest 12 located within the shoe (sole). The signal 18 is continuously transmitted and reflected while the reflected signal is received by the scanner 10 during the process of entering the scanner 10, e.g. stepping onto the platform 40. This is shown in FIGS. 3B, 3C, 4B and 4C.

This way, the person 44, here the foot 58 of the person 44, can be scanned piece by piece along a longitudinal axis of the foot 58 as the foot 58 of the person 44 moves across the antenna array 26.

Additionally, as the antenna array 26 comprises a plurality of antennas 24 positioned next to each other along a line at the entrance 48 of the scanner 10, the shoe is scanned in a perpendicular direction, namely along a transverse axis, e.g. in a vertical direction. In other words, the person 44 moves in a horizontal direction when entering the scanner 10 while the signal(s) 18 impinge on the person 44 in a vertical direction, thereby penetrating the person 44 from below at least partly.

The scanning process is continued until the foot 58 of the person 44 has left the signal 18 transmitted by the antenna array 26, for example by completely stepping onto or off the platform 40 as shown in FIGS. 3D and 4D.

At this point, according to step S3, the range image is constructed from the received signal 18 and, according to step S4, analyzed by the evaluation circuit 38, thereby obtaining an analyzation result.

Based on the analyzation result a presence of the object of interest 12 may be detected using, for example, the detection algorithm 39 and/or the AI 41 comprised in or associated with the evaluation circuit 38, as indicated in step S5.

If an object of interest 12 is detected, the scanner 10 can alert an operator of the scanner 10 such that a more detailed security check may be performed. The scanner 10 may alert the operator for example by sounding an alarm sound or flashing a light.

In an embodiment where the scanner 10 comprises a motion sensor(s) 36, the motion sensor 36 detects and measures the movement and velocity of the foot 58 of the person 44. As the person 44 is potentially carrying the object of interest 12, the movement and velocity of the object of interest 12 are measured as well.

In an embodiment, the measurement performed by the motion sensor 36 may be performed at the same time as the scan so that the data obtained by the motion sensor 36 can be combined with the received signal 18 more easily. Put differently, data collected by the motion sensor 36 is processed with data associated with received signal 18 such that the resolution of the range image can be improved.

In another embodiment, in order to obtain an even more significant result and avoid false alarms, the same scanning process can be performed when the person 44 is leaving the platform 40 at an exit 50 with a second range imaging setup 20.

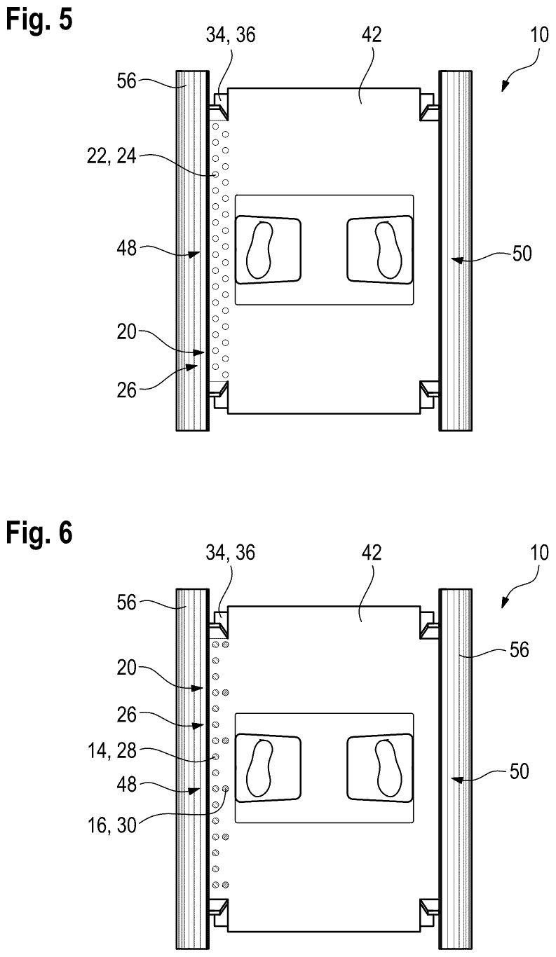

FIG. 5 shows the antenna array 26 established, for example, by a monostatic offset array. Put differently, each antenna 24 of the antenna array 26 is provided with more installation space as the antennas 24 are arranged in two rows instead of one.

In FIG. 6, the antenna array 26 is established, for example, by a multistatic array. For instance, all receiving antennas 30 are positioned in one line wherein all transmission antennas 28 are positioned in a second line parallel to the first line.

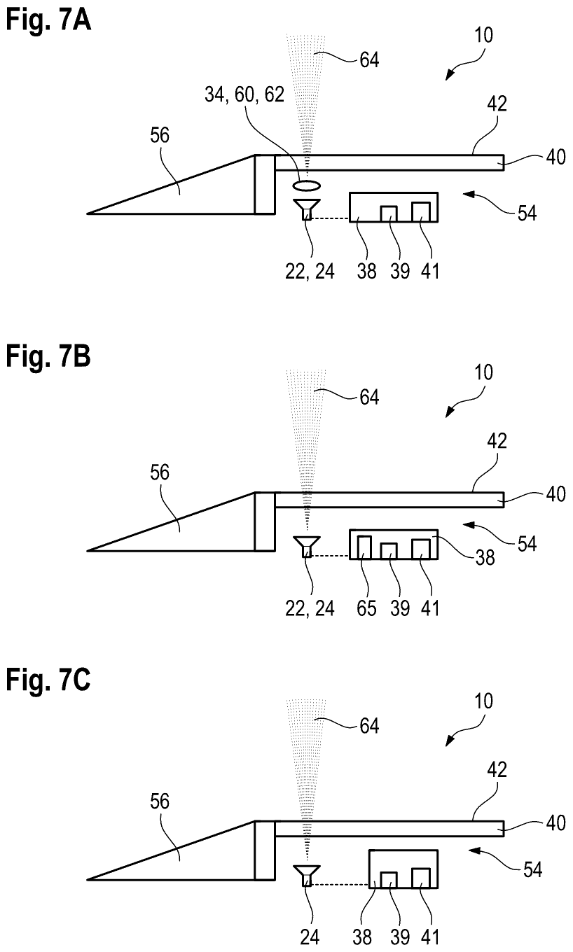

As shown in the embodiment of FIG. 7A, the beam and/or range focuser 34 is given by a separately formed focusing device 60 that is located in front of the transceiver 22 such that the transmitted signal 18 and the received signal 18 are focused by the focusing device 60. For instance, the focusing device 60 is a lens 62.

In an embodiment, the lens 62 is used to shape the transmitted signal 18 into a fan beam whose small width is pointed the direction of motion. Accordingly, the detection area provided by the fan beam 64 extends along the edge 46 of the scanner 10 but only covers a narrow area in the direction of motion. Accordingly, the motion sensor 36 is not required as the width of the detection area is small enough to determine the point of measurement accurately.

According to an alternative embodiment of the beam and/or range focuser 34 shown in FIG. 7B, the fan beam 64 is not created by a separately formed focusing device 60 but instead by a software for beamforming 65 or 3D lens imaging which may also be comprised on the processor circuit carrying the evaluation circuit 38. The fan beam 64 may also be obtained during a post-processing by the software.

FIG. 7C shows a further alternative embodiment of the beam and/or range focuser 34, wherein the beam and/or range focuser 34 is implemented in the antennas such that fan beam antennas are provided. Hence, neither a motion sensor 36 nor a focusing device 60 are required, and thus, can be omitted.

In any case, an improved resolution for the range image can be provided without requiring information about the movement of the object of interest 12 and the person 44 carrying the object of interest 12 as the detection area is narrow enough to confidently determine the point of measurement.

FIG. 8 shows scanner 10 in a perspective view, thereby better illustrating that the scanner 10 further comprises at least one detector 66. In an embodiment, the detector 66 comprises a first detector panel 68 and a second detector panel 70 which are positioned at a distance from each other. Since the first and second detector panels 68, 70 are positioned at distance from each other a passage 72 is defined between them.

As can be seen in FIG. 8, the platform 40 is positioned orthogonal to the first and second detector panels 68, 70. For example, the range imaging setup 20 can be positioned in a plane perpendicular to an extension direction of the first detector panel 68 and the second detector panel 70.

In an embodiment, the detector 66 may be, for example, a radar body scanner system which is typically used at airports and other access points to restricted areas. Accordingly, the first and second detector panels 68, 70 may comprise antennas which are used to scan a body of the person 44 in a lateral manner in order to detect any objects of interest 12 carried in a torso region, underneath the shirt or underneath the trousers.

In order to obtain one range image with the highest resolution possible, the evaluation circuit 38 is configured to combine data obtained from the signal 18 and data received from the detector 66.

Optionally, a platform 74 (dashed lines) may be provided on top of the detector panels 68, 70 such that a scan can be performed from above, thereby scanning for an object of interest 12 in a headgear.

Generally, an increased amount of angles can be provided in case of having the optional platform 74 as well, thereby providing a more complete and detailed range image.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein, or parts thereof, can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as t beam and/or range focuser 34, the evaluation circuit 38, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A scanner for detecting an object of interest, the scanner comprising
at least one transmitter and/or at least one receiver for transmitting and/or receiving a signal in a range imaging setup,
a beam and/or range focuser for improving the resolution of an obtained range image, and
an evaluation circuit configured to analyze the signal for creating a range image and to determine the object of interest based on the range image created,
wherein the scanner is an access control scanner for controlling access to a restricted area, and
wherein the scanner is configured to detect the presence of the object of interest using range imaging while the object of interest is moving relative to the scanner.

2. The scanner according to claim 1, wherein the at least one transmitter and the at least one receiver are formed as at least one transceiver.

3. The scanner according to claim 1, wherein the scanner comprises at least one antenna array comprising several antennas, and wherein the several antennas comprise transmission antennas and receiving antennas.

4. The scanner according to claim 3, wherein the at least one antenna array is a monostatic array or a multistatic array.

5. The scanner according to claim 1, wherein the beam and/or range focuser comprises a motion sensor, and wherein the motion sensor is configured to determine and measure the movement of the object of interest.

6. The scanner according to claim 5, wherein the evaluation circuit is connected with the motion sensor, and wherein the evaluation circuit is configured to create the range image using the signal and data received from the motion sensor.

7. The scanner according to claim 5, wherein the scanner is an inverse synthetic aperture radar (ISAR), and wherein the evaluation circuit is configured to create the range image using data received from the inverse synthetic aperture radar and data received from the motion sensor.

8. The scanner according to claim 1, wherein the beam and/or range focuser comprises a focusing device.

9. The scanner according to claim 8, wherein the focusing device is located in front of the at least one transmitter and/or the at least one receiver such that a transmitted signal and/or a signal to be received is focused by the focusing device.

10. The scanner according to claim 1, further comprising a platform onto which a standing surface for a person is provided, and wherein the at least one transmitter and/or the at least one receiver are/is positioned at an edge of the platform, which is assigned to an entrance and/or an exit of the scanner.

11. The scanner according to claim 1, further comprising a platform, the platform being elevated compared to a floor on which the scanner is installed so as to establish an accommodation space for the at least one transmitter and/or the at least one receiver.

12. The scanner according to claim 1, further comprising:
at least one detector with a first detector panel and a second detector panel, wherein the first panel and the second panel are positioned at a distance from each other such that a passage is defined between the first panel and the second panel,
wherein the at least one transmitter and/or the at least one receiver are/is positioned in a plane perpendicular to an extension direction of the first detector panel and the second detector panel.

13. The scanner according to claim 12, wherein the evaluation circuit is configured to combine data obtained from the signal and data received from the detector.

14. The scanner according to claim 1, wherein the at least one transmitter and/or the at least one receiver are/is maintained within position during the scanning.

15. A method for detecting an object of interest, comprising:
providing a scanner that is an access control scanner for controlling access to a restricted area,
performing a scan with the scanner by transmitting a signal and receiving a reflected signal while the object of interest is moving relative to the scanner;
constructing a range image from the received signal;
analyzing the range image, thereby obtaining an analyzation result; and
detecting the presence of the object of interest by using the analyzation result.

16. The method according to claim 15, wherein a resolution of the range image is enriched by processing data associated with the received signal with data collected by a motion sensor, wherein the motion sensor detects the movement and velocity of the object of interest.

17. The method according of claim 15, wherein a resolution is improved by creating a fan beam.

18. The method according to claim 15, wherein at least one detector with a first detector panel and a second detector panel is used additionally, wherein the first detector panel and the second detector panel are positioned at a distance from each other such that a passage is formed between the first detector panel and the second detector panel.

19. The method according to claim 18, wherein at least one transmitter and/or at least one receiver, used for performing the scan while the object of interest is moving relative to the scanner, are/is positioned in a different plane than the first detector panel and the second detector panel, and wherein data associated with the signal received is combined with data received from the at least one detector.

20. The method according to claim 19, wherein the at least one transmitter and/or the at least one receiver are/is positioned at an entrance and/or an exit of the scanner such that a person entering and/or leaving the scanner is scanned during its motion by using the at least one transmitter and/or the at least one receiver.
